(19) United States
(12) Patent Application Publication
(10) Pub. No.: US 2013/0234951 A1
(43) Pub. Date: Sep. 12, 2013

(54) PORTABLE DEVICE AND METHOD FOR CONTROLLING THE SAME

(71) Applicants: Jihwan Kim, Seoul (KR); Kihyung Kim, Seoul (KR); Jihyun Kim, Seoul (KR)

(72) Inventors: Jihwan Kim, Seoul (KR); Kihyung Kim, Seoul (KR); Jihyun Kim, Seoul (KR)

(21) Appl. No.: 13/416,686

(22) Filed: Mar. 9, 2012

(51) Int. Cl. G06F 3/041

(52) U.S. Cl. 345/173

(57) ABSTRACT

A portable device is disclosed. The portable device of our invention includes a flexible display, a housing that contains the flexible display, a measurement sensor for measuring a distance by which the flexible display has been extended from the portable device when the flexible display is extended from the housing, and a display control unit for displaying an image including at least one icon on the extended flexible display according to the measured distance, wherein the display control unit adjusts the image display when the at least one icon is partially displayed on the extended flexible display.

### BACKGROUND OF THE INVENTION

1. Field of the Invention

The present invention relates to a portable device, and more particularly, to a portable device including a flexible display and a method for controlling the portable device.

2. Discussion of the Related Art

Mobility has always been an important issue with regard to use of electronic devices. Not only cellular phones but also various other portable electronic devices having performance comparable to desktop computers have entered the market recently. Such portable electronic devices have been reduced in size and weight to allow users to use a variety of digital information while in motion.

Portable devices perform various functions in addition to basic conventional functions such as data transmission and reception. Thus, the portable device needs to be able to be more easily and accurately controlled by the user. Especially, along with spread of flexible display panels, some recent portable devices have become able to extend the display using a flexible display panel. Thus, there is a need to provide a control method for providing user convenience according to display extension.

### SUMMARY OF THE INVENTION

Accordingly, the present invention is directed to a portable device and a method for controlling the same that substantially obviate one or more problems due to limitations and disadvantages of the related art.

An object of the present invention is to provide a portable device and a method for controlling the same, which allow the user to more accurately and conveniently control the portable device.

Another object of the present invention is to provide a portable device and a method for controlling the same, wherein, when the portable device includes a flexible display panel, image display of the flexible display panel is controlled to provide a convenient user interface to the user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a portable device comprises a flexible display, a housing that contains the flexible display, a measurement sensor for measuring a distance by which the flexible display has been extended from the portable device when the flexible display is extended from the housing, and a display control unit for displaying an image including at least one icon on the extended flexible display according to the measured distance, wherein the display control unit adjusts the image display when the at least one icon is partially displayed on the extended flexible display.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a flexible display according to an embodiment of the present invention.

FIG. 2 illustrates a portable device that contains a flexible display according to an embodiment of the present invention.

FIG. 3 illustrates a portable device according to an embodiment of the present invention.

FIG. 4 is a block diagram illustrating a portable device according to an embodiment of the present invention.

FIG. 5 illustrates image display of a portable device according to an embodiment of the present invention.

FIG. 6 illustrates a method for controlling display a portable device according to an embodiment of the present invention.

FIG. 7 illustrates a method for controlling display of a portable device according to an embodiment of the present invention.

FIG. 8 illustrates a method for controlling display of a portable device according to another embodiment of the present invention.

FIG. 9 illustrates a method for controlling display of a portable device according to another embodiment of the present invention.

FIG. 10 illustrates a method for controlling display of a portable device according to another embodiment of the present invention.

FIG. 11 illustrates a method for controlling display of a portable device according to another embodiment of the present invention.

FIG. 12 illustrates a method for displaying an image of a portable device according to another embodiment of the present invention.

FIG. 13 illustrates a method for displaying an image of a portable device according to another embodiment of the present invention.

FIG. 14 is a flowchart illustrating a method for controlling a portable device according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Although most terms of elements in the present invention have been selected from general ones widely used in the art taking into consideration functions thereof in the invention, the terms may be changed depending on the intention or convention of those skilled in the art or the introduction of new technology. Some terms have been arbitrarily selected by the applicant and their meanings are explained in the following description as needed. Thus, the definitions of the terms used in the invention should be determined based on the overall content of this specification together with the intended meanings of the terms rather than their simple names or meanings.

Digital devices have been decreased in size through development of electronic device manufacturing technology. The present invention relates to movable, portable electronic devices which will be collectively referred to as portable devices. Portable devices include a variety of movable electronic devices, examples of which include electronic devices such as a cellular phone, a Personal Digital Assistant (PDA), a laptop, a tablet PC, an MP3 player, a CD player, and a DVD player. In the following description, the portable device may also be referred to as a device for short.

A flexible display has been commercialized along with development of display technology. The term “flexible display” refers to a display that is bendable, foldable, or rollable without losing display properties, unlike a conventional hard display panel. The flexible display is also referred to as “e-paper”. The flexible display is characterized in that it is light, thin, impact-resistant, and freely bent, compared to a conventional hard display.

A substrate of the flexible display may be formed of a metal foil, a very thin sheet of glass, or a plastic substrate. Especially, the flexible display may use, as the plastic substrate, a PC substrate, a PET substrate, a PES substrate, a PI substrate, a PEN substrate, an AryLite substrate, or the like.

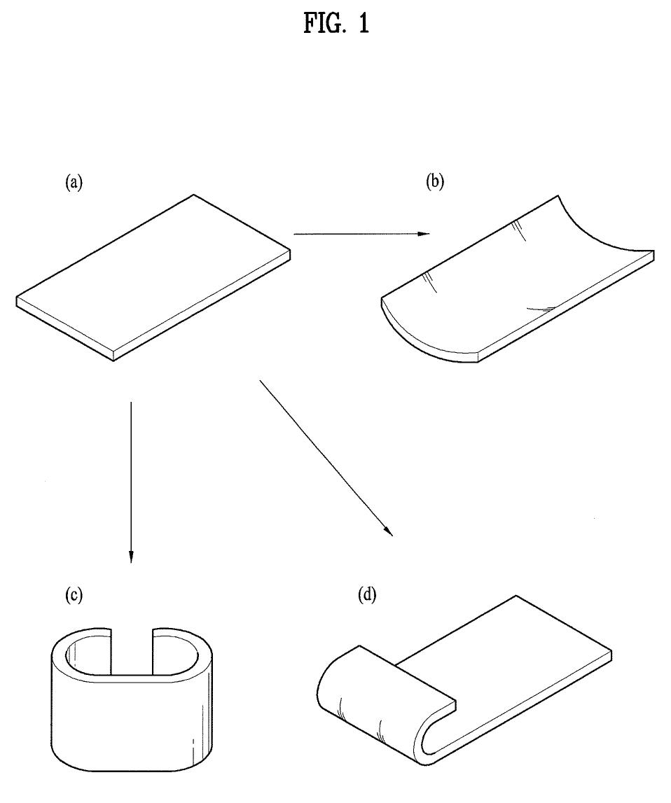

FIG. 1 illustrates a flexible display according to an embodiment of the present invention.

The flexible display of FIG. 1 may be classified into a bendable display as shown in FIG. 1(b), a foldable display as shown in FIG. 1(c), and a rollable display as shown in FIG. 1(d) according to flexibility or the extent of flexibility.

When a portable device contains such a flexible display, it is possible to provide a display having a larger size than that of the portable device. In the following description, the flexible display may also be referred to as a flexible display unit, a flexible display screen, or a flexible display panel. The term “flexible display”, as used in the following description, refers to any type of flexible display that can be bent into any shape including the shapes shown in FIG. 1 without losing display properties. The flexible display includes a touch sensor such that the flexible display can sense a touch input that the user has performed upon the display and operate according to the touch input.

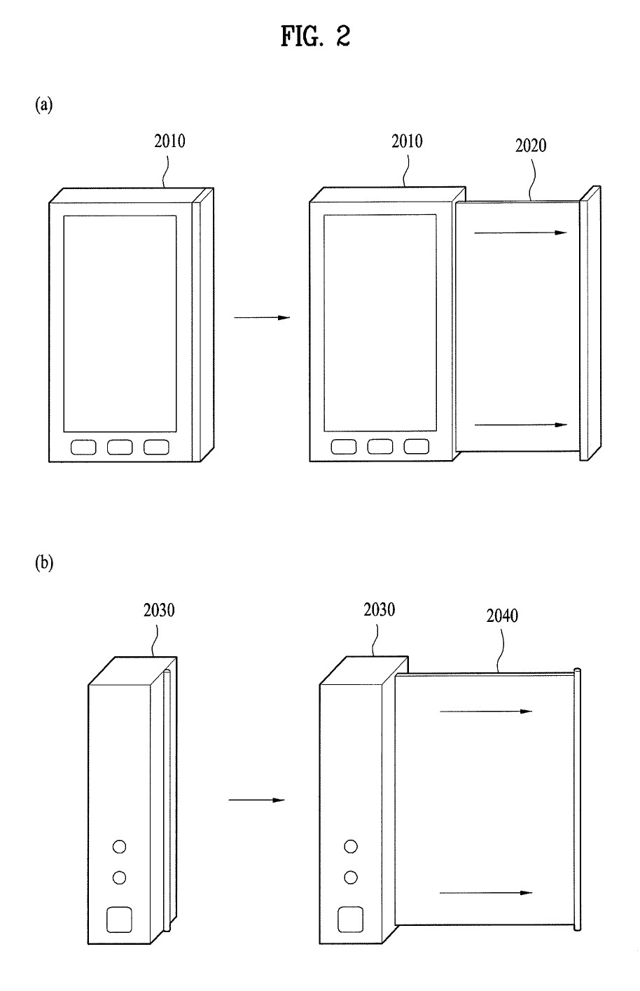

FIG. 2 illustrates a portable device that contains a flexible display according to an embodiment of the present invention.

When a flexible display is used, it is possible to provide a display having a larger size than that of the portable device. Since the flexible display is bendable, the flexible display can be contained in a small volume in the device. That is, the flexible display as shown in FIG. 1 may be folded or rolled to be contained in the portable device and the user may extend the flexible display from the portable device when the user desires to use the display or the larger display.

FIG. 2(a) illustrates a portable device according to an embodiment of the present invention. Specifically, FIG. 2(a) shows a portable device 2010 that includes its own display. The display may be provided at a front side of the portable device 2010 and buttons may be provided at any portion of the portable device 2010. The entirety of the front side may be composed of a display and buttons may be displayed as corresponding images on the display.

The portable device 2010 contains a flexible display 2020. When the user desires to use an additional display, the flexible display 2020 may be manually or automatically extended.

FIG. 2(b) illustrates a portable device according to another embodiment of the present invention. Specifically, FIG. 2(b) shows a portable device 2030 that does not include its own display or includes only a small display such that the portable device 2030 has a smaller display size than that of FIG. 2(a). A flexible display 2040 may be rolled up to be contained in the portable device 2030 and the flexible display 2040 may be manually or automatically extended when the user desires to use an additional display.

The following description is given with reference to a portable device including the flexible display as shown in FIG. 2 as an example. However, the portable device is not limited to the types shown in FIG. 2 and may be any of a variety of portable displays that include an extendible flexible display.

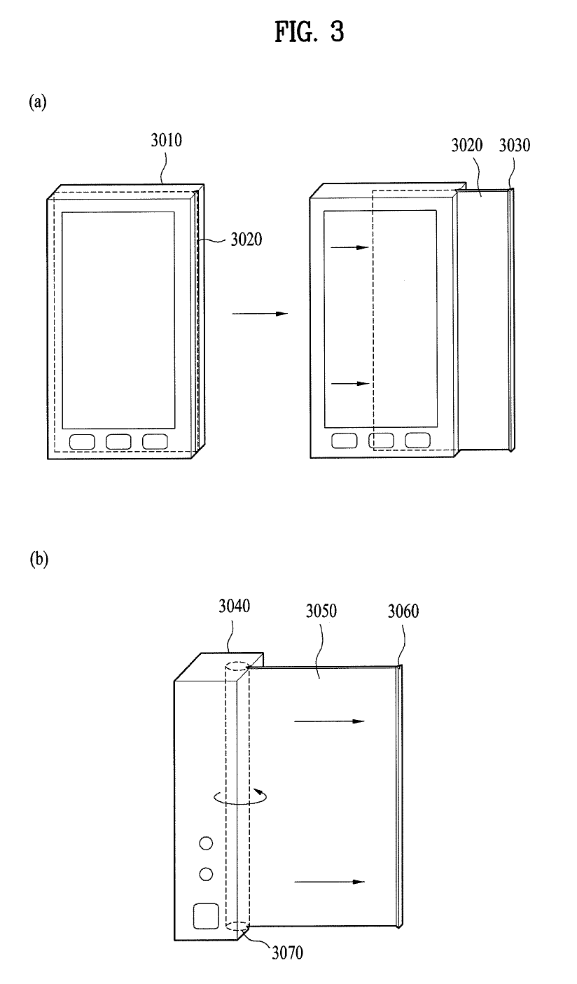

FIG. 3 illustrates a portable device according to an embodiment of the present invention.

Specifically, FIG. 3 shows a portable device, a flexible display included in the portable device, and a housing that receives the flexible display.

FIG. 3(a) illustrates an example in which a flexible display 3020 is folded and received in a portable device 3010. When the user desires to extend the display, the user may pull the flexible display 3020 out using a handle 3030 provided on the flexible display 3020. The flexible display 3020 is received in the housing of the portable device 3010. That is, the flexible display is folded or rolled and received in the housing in the portable device 3010. In the example of FIG. 3(a), the flexible display 3020 is folded or rolled into an approximately folded shape to be received in the housing. The housing may be automatically pulled out according to device control by the user.

FIG. 3(b) illustrates an example in which a flexible display 3050 is rolled and received in a portable device 3040. When the user desires to extend the display, the user may extend the flexible display 3050 using a handle 3060 provided on the flexible display 3050. In the example of FIG. 3(b), the flexible display 3050 is rolled and received in a housing 3070. In this case, the housing 3070 may automatically pull the flexible display 3050 out according to device control by the user.

When the flexible display is extended, the portable device may display an image on the display having an extended area or size. In this specification, the term “image” refers to as a still image or a moving image that can be displayed on a display panel or any other type of image that can provide a visual expression.

The portable device may include a measurement sensor that measures a distance by which the flexible display is pulled out or extended. According to an embodiment, such a measurement sensor or sensor unit may be externally or internally provided to the portable device or may be provided on or near the housing of the portable device from which the flexible display is extended.

The portable device or the flexible display shown in FIGS. 2 and 3 is merely exemplary and a folded flexible display may be extended in a different manner than shown in FIGS. 2 and 3. The housing may be located at positions different from those shown in the examples of FIGS. 2 and 3. A description will be given of a portable device including such a housing that receives an extendable flexible display as described above.

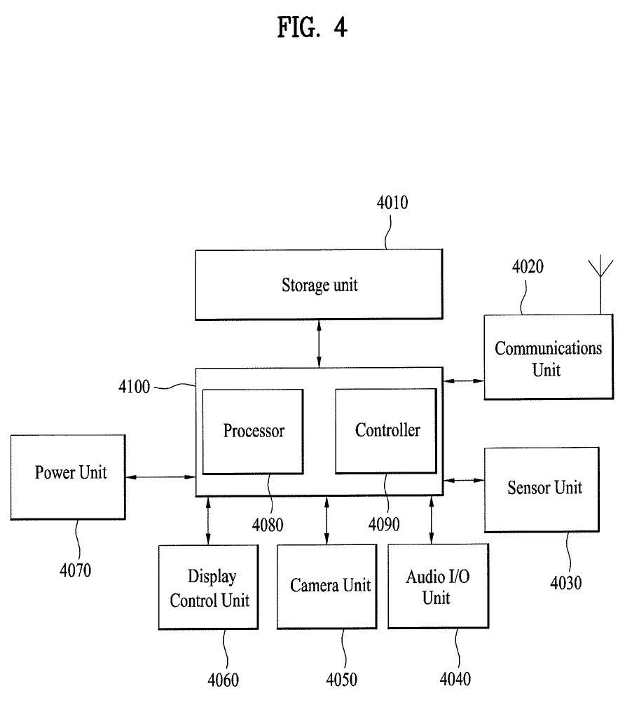

FIG. 4 is a block diagram illustrating a portable device according to an embodiment of the present invention.

As shown in FIG. 4, the portable device includes a storage unit 4010, a communications unit 4020, a sensor unit 4030, an audio I/O unit 4040, a camera unit 4050, a display control unit 4060, a power unit 4070, a processor 4080, and a controller 4090.

The storage unit 4010 may store a variety of digital data such as video, audio, photographs, moving images, and applications. The storage unit 4010 is one of a variety of digital data storage media such as a flash memory, a Hard Disk Drive (HDD), and a Solid State Drive (SSD).

The communications unit 4020 may perform communication with an external entity using various protocols to transmit and/or receive data. The communications unit 4020 may connect to an external network wirelessly or by wire to transmit and/or receive digital data.

The sensor unit 4030 may identify user environments or user inputs using a plurality of sensors provided in the portable device and deliver the identified environments or user inputs to the controller 4090. The sensor unit 4030 may include a variety of sensing means. For example, the plurality of sensing means may include a gravity sensor, a geomagnetic sensor, a motion sensor, a gyro sensor, an acceleration sensor, a slope sensor, a brightness sensor, a height sensor, an odor sensor, a temperature sensor, a depth sensor, a pressure sensor, a bending sensor, an audio sensor, a video sensor, a Global Positioning System (GPS) sensor, and a touch sensor. In the present invention, the sensor unit may include an extended display area/distance measurement sensor that measures or senses an extended area or distance of the flexible display. The sensor unit 4030, which is a term collectively referring to the variety of sensing means, may sense and deliver a variety of user inputs and user environments to allow the device to perform corresponding operations. The sensors may be included as additional elements in the device or may be combined into at least one element and included in the device.

The audio I/O unit 4040 may include an audio output means such as a speaker and an audio input means such as a microphone and may perform audio input and audio output. The audio I/O unit 4040 may also be used as an audio sensor.

The camera unit 4050 may capture still images and moving images and may optionally be provided in the device depending on the embodiment of the device. The camera unit 4050 may also be used as the motion sensor or the visual sensor.

The display control unit 4060 may display an image on a screen. The display control unit 4060 may be used as the touch sensor when the display is a touch sensing display and may be used as the bending sensor when the device is flexible. When the flexible display is extended, the display control unit 4060 may display an image according to the extended display area. That is, the display control unit 4060 may perform a control operation to display an image by adjusting the size, resolution, or the like of the image according to the extended display size and to display another image according to the size. The display control unit 4060 may function to display an image on the display panel or to perform image display control.

The power unit 4070 may be a battery provided in the device or a power source connected to an external power source and may supply power to the device.

The processor 4080 may execute a variety of applications stored in the storage unit 4010 and may process data in the device.

The controller 4090 may control the units of the device and may manage data transmission and reception between the units.

The processor 4080 and the controller 4090 may be implemented as a single chip to perform the operations described above together. This single chip may be referred to as a controller 4090 in the following description.

The elements of the portable device are shown as logically separate blocks in FIG. 4, which is a block diagram of the portable device according to an embodiment of the present invention. The elements of the device may be mounted as a single chip or a plurality of chips in the device depending on design of the device.

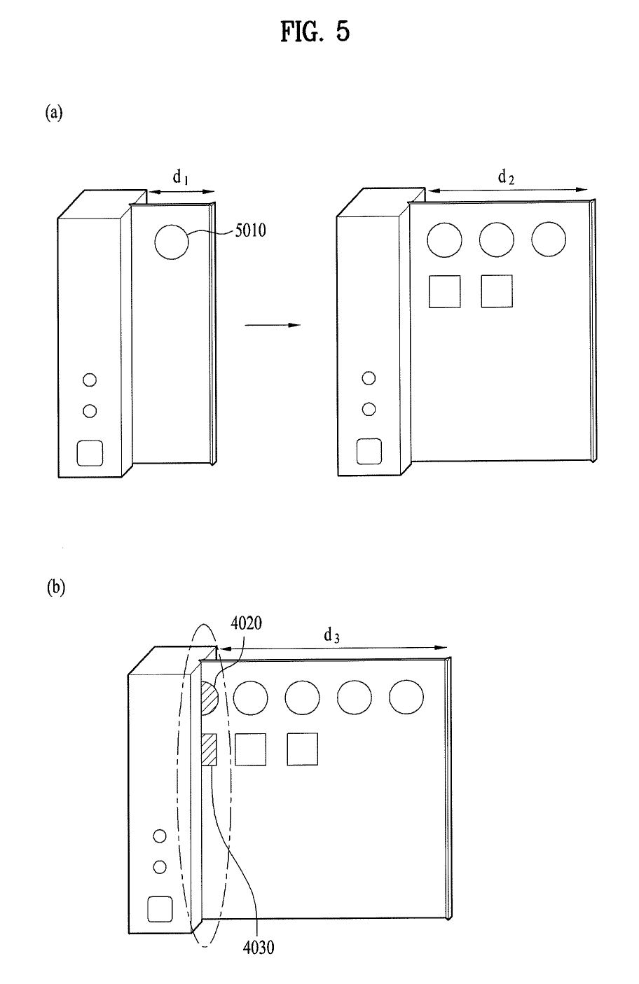

FIG. 5 illustrates image display of a portable device according to an embodiment of the present invention.

The portable device includes a flexible display that is extendable from the portable device as described above. The portable device may start displaying an image as the flexible display is extended from the portable device as described above. The portable device may display another image according to the extended size of the flexible display.

Recent portable displays may execute various applications. To execute such an application, the user needs to input a launch command corresponding to the application. A launch command of an application may be displayed as a Graphical User Interface (GUI) to allow the user to easily access and execute the application. The present invention will be described with reference to an exemplary portable device which displays such a GUI as an icon and hereinafter the GUI may also be referred to as an icon.

The flexible display of the portable device may display an image including an icon 5010 as shown in FIG. 5 as the display is extended. FIG. 5 illustrates an example in which the portable device displays an image including an icon as the flexible display is extended or pulled out.

In the example of FIG. 5(a), when the flexible display is extended from the portable device to a first distance d1, the portable device may detect a displayable area of the flexible display corresponding to the distance. The portable device may display an image including icons that are displayable within the distance d1 in the area. The types and the display order of icons may differ in each embodiment. For example, a basic menu icon may first be displayed and icons corresponding to other applications may then be displayed. Alternatively, icons may be displayed in an order set by the user. Another set of icons may be displayed according to the extended display area.

In the example of FIG. 5(a), the portable device may display only one icon 5010 according to an area corresponding to the first distance d1 when the flexible display is extended to the first distance d1 and may display a plurality of icons according to an extended area corresponding to the second distance d2 when the flexible display is extended to the second distance d2. That is, the portable device may sequentially display icons in an image to be displayed as the display is extended. Namely, image display may be performed as though an image including a plurality of icons, which has been displayed on the flexible display within the portable device, is extended as the flexible display is extended.

FIG. 5(b) illustrates display of icons when the flexible display has been extended to a third distance d3. When the portable device displays icons according to extension of the flexible display, the icons may be displayed on the portable device at a boundary between the portable device and the flexible display. In addition, icons 4020 and 4030 located at a boundary may be partially displayed rather than being fully displayed. In this case, the partially displayed icons 4020 and 4030 may cause user inconvenience. The user may pull the flexible display in or out according to how much the partially displayed icons are needed. It may also be difficult for the user to touch the partially displayed icons when trying to touch the icons to execute applications represented by the icons. The following is a description of a method for adjusting and processing display of icons that cannot be fully displayed when such icons are generated or displayed as the flexible display is extended as shown in FIG. 5(b).

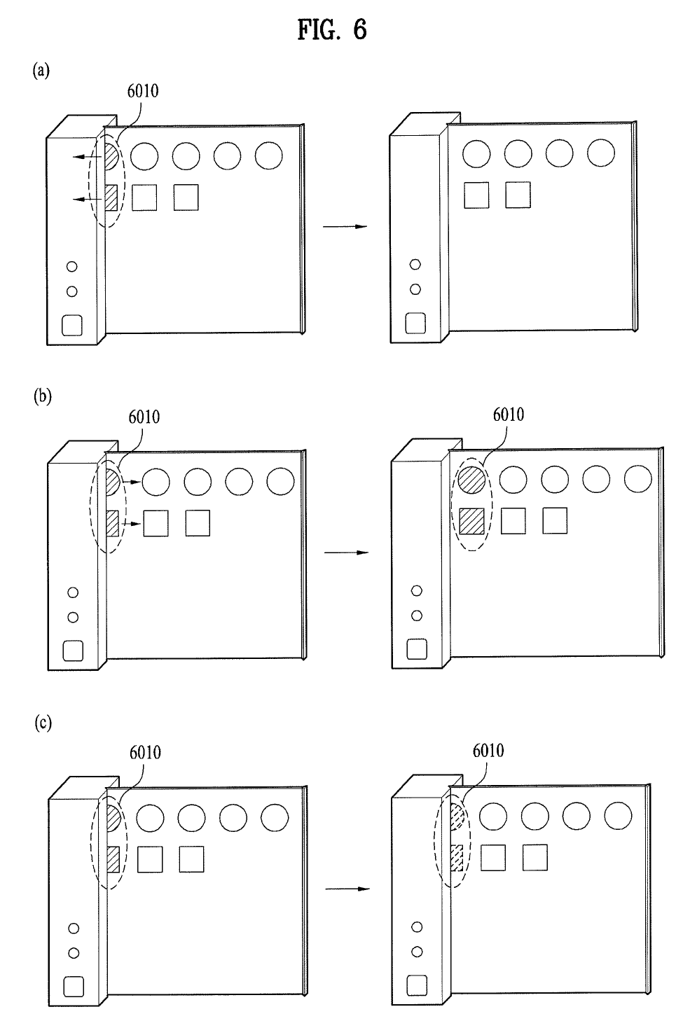

FIG. 6 illustrates a method for controlling display of a portable device according to an embodiment of the present invention.

Left figures of FIGS. 6(a) to 6(c) show a portable device in which icons 6010 are not fully displayed on the portable device at a boundary between the flexible display and the portable device as the flexible display is extended as in FIG. 5(b). Particularly, FIG. 6 illustrates a method for automatically adjusting display of the icons 6010 when the icons 6010 are partially displayed on the portable device at the boundary between the flexible display and the portable device. When the icons are partially displayed at the boundary, display of the icons may be adjusted such that the icons are fully displayed, the icons may not be displayed, or a visual effect may be imparted to the icons.

FIG. 6(a) illustrates a method for adjusting image display such that the icons 6010 located at the boundary are not displayed. The portable device may adjust an image that is displayed on the flexible display using the display control unit. In the case of FIG. 6(a), the displayed image may be adjusted such that the icons 6010, which have been partially displayed since they are located at the boundary, are not displayed as shown in the right figure of FIG. 6(a). The portable device may move the displayed image to the left such that the icons 6010 are not viewed on the screen. The portable device may also adjust the ratio, resolution, size, or the like of the screen while moving the image to the left.

FIG. 6(b) illustrates a method for adjusting image display such that the icons 6010 located at the boundary are fully displayed. The portable device may adjust an image that is displayed on the flexible display using the display control unit. In the case of FIG. 6(b), the displayed image may be adjusted such that the icons 6010, which have been partially displayed since they are located at the boundary, are fully displayed as shown in the right figure of FIG. 6(b). The portable device may move the displayed image to the right such that the icons 6010 are fully viewed on the screen. The portable device may also adjust the ratio, resolution, size, or the like of the screen while moving the image to the right.

FIG. 6(c) illustrates a method in which icons 6010 that are located at the boundary are displayed in a different manner from other icons by imparting a visual effect to the icons 6010. The portable device may display the icons 6010 that are located at the boundary such that the icons 6010 are transparent or opaque. In an embodiment, the icons 6010 located at the boundary may be processed to be shaded or may be displayed in a different color from other displayed icons. Alternatively, icons other than the icons 6010 located at the boundary may be highlighted.

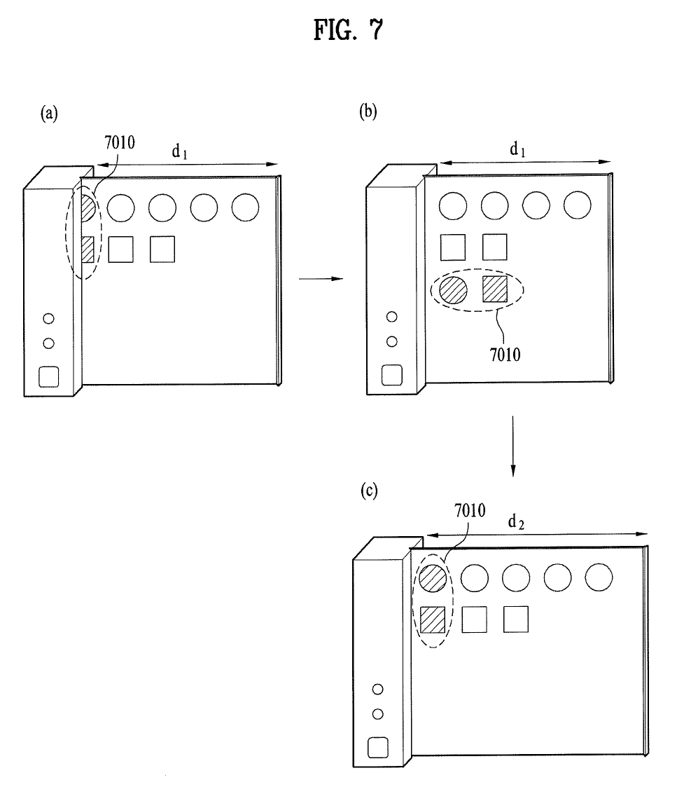

FIG. 7 illustrates a method for controlling display of a portable device according to an embodiment of the present invention.

FIG. 7(a) shows the case in which icons 7010 are not fully displayed on the portable device at a boundary between the portable device and the flexible display since the flexible display is pulled out to the first distance d1 as described above. In this case, the portable device may move the icons 7010 that are not fully displayed such that the icons 7010 are fully displayed together with other icons. That is, the portable device may adjust image display by moving the icons, which are located at the boundary between the flexible display and the portable device, to below other icons such that the icons are fully displayed. In the embodiment of FIG. 7(b), the icons 7010, which are located at the boundary, may be displayed at arbitrary positions of the flexible display such that all icons are displayed.

After the icons 7010 are moved as shown in FIG. 7(b), the flexible display may be further pulled out automatically or manually by the user. When the flexible display is extended to a distance d2 where all icons are displayable, the portable device may display the icons by moving the icons 7010 back to the originally intended positions as shown in FIG. 7(c).

The methods of FIGS. 6 and 7 may be performed according to the extent to which boundary icons are displayed. For example, when most portions of the boundary icons are displayed such that only small portions thereof are located within the portable device, no significant user inconvenience may be caused even when the display is maintained. Accordingly, whether or not to adjust display may be determined according to the displayed area of the boundary icons or according to the extent to which the boundary icons are displayed.

For example, the current image display of icons may be maintained when at least ½ or ⅔ of the area of each icon located at the boundary is displayed and the display of the icons may be adjusted as described above with reference to FIGS. 6 and 7 when less than ½ or ⅔ of the area is displayed. Whether or not to adjust display may also be determined according to an arbitrary criterion that may be set by the user. Display may also be adjusted according to the size or area of the extended flexible display. A method and operation for adjusting image display may be performed according to a specific criterion such as the displayed area or size of each of the icons that are partially displayed at the boundary.

The following is a description of a method in which the user directly adjusts display through touch input.

Unlike what has been described above with reference to FIGS. 6 and 7, the user may directly adjust display using touch input. That is, the user may adjust display of icons, which are not fully displayed since they are located at the boundary, using touch input.

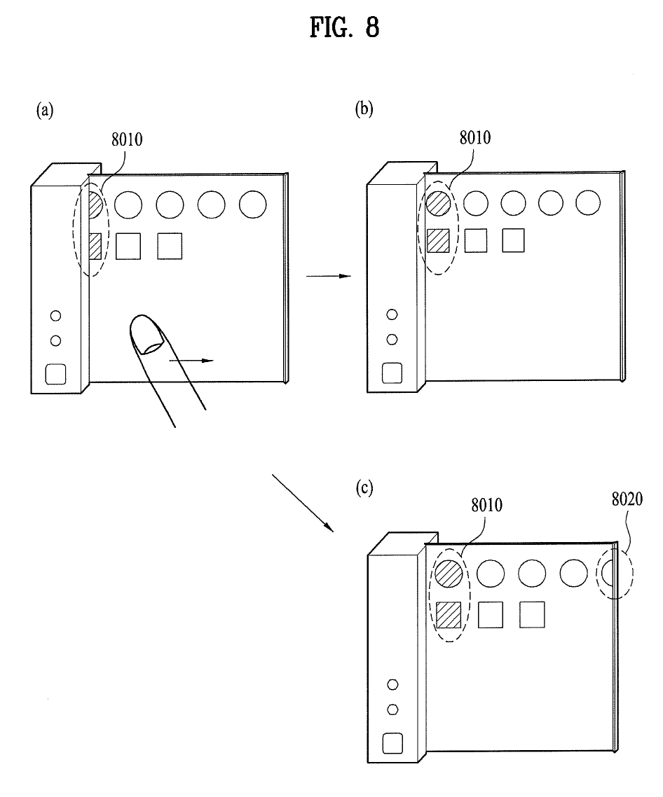

FIG. 8 illustrates a method for controlling display of a portable device according to another embodiment of the present invention.

Specifically, FIG. 8 illustrates a method in which the user adjusts displayed images through touch input upon a flexible display. That is, if some icons are not fully displayed at the boundary as shown in FIG. 8(a) when the flexible display has been pulled out, the user may adjust the displayed image through a touch and slide input. FIG. 8 illustrates an example in which the user has slid a touch input to the right on the flexible display.

The portable device may move the icons in the same direction as the direction in which the touch input has been slid. That is, the portable device may move icons 8010 located at the boundary to the right such that the boundary icons 8010 are fully displayed as shown in FIG. 8(b). In the case of FIG. 8(b), the portable device adjusts display by reducing the intervals between icons or reducing the sizes of all icons such that the boundary icons 8010 are fully displayed in the currently pulled-out flexible display region. In the case of FIG. 8(c), the portable device moves the image or the positions of the icons to the right while keeping the intervals or sizes of the icons unchanged. In the case of FIG. 8(c), the portable device may move the image to the right according to the extent of touch and slide performed by the user. As a result, the image may be displayed such that an icon 8020 located at the rightmost on the display exits the display to the right as shown in FIG. 8(c). Controlling the display as shown in FIG. 8(c) may allow the user to slide the entirety of the menu screen to the right using touch and slide.

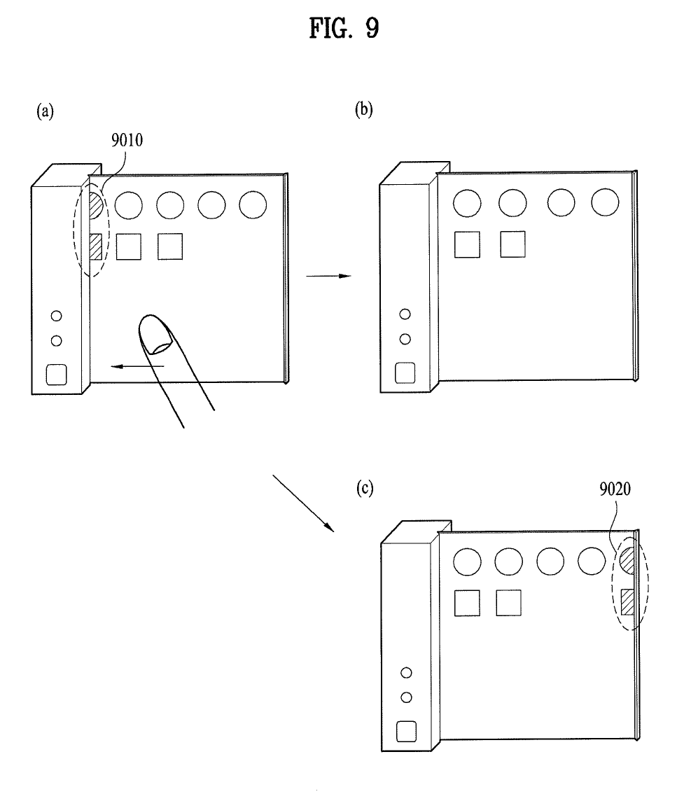

FIG. 9 illustrates a method for controlling display of a portable device according to another embodiment of the present invention.

Specifically, FIG. 9 illustrates a method in which the user adjusts displayed images through touch input upon a flexible display. That is, if some icons are not fully displayed at the boundary as shown in FIG. 9(a) when the flexible display has been pulled out, the user may adjust the displayed image through a touch and slide input. FIG. 9 illustrates an example in which the user has slid a touch input to the left on the flexible display.

The portable device may move the icons in the same direction as the direction in which the touch input has been slid. That is, the portable device may move icons 9010 located at the boundary to the left such that the boundary icons 9010 are not displayed as shown in FIG. 9(b). In the case of FIG. 9(b), the portable device adjusts display by increasing the intervals between icons or increasing the sizes of all icons such that the boundary icons 9010 are not displayed on the currently pulled-out flexible display region. In the case of FIG. 9(c), the portable device moves the image or the positions of the icons to the left while keeping the intervals or sizes of the icons unchanged. In the case of FIG. 9(c), the portable device may move the image to the left according to the extent of touch and slide performed by the user. As a result, the image may be displayed such that icons 9020, which have not been displayed on the display menu, enter the display to the left as shown in FIG. 9(c). Controlling the display as shown in FIG. 9(c) may allow the user to slide the entirety of the menu screen to the left using touch and slide.

When icons are not fully displayed at the boundary between the flexible display and the portable device, not only may icon display cause user inconvenience but touching at the boundary may also be a problem. Touch-input enabled displays can identify a touch only when the touch is made upon more than a specific area. In addition, when the user has touched an icon to execute a corresponding operation, the device can identify the touch only when the touch is made upon more than a specific area of the icon. If the icon is located at the boundary as described above, the user may not touch more than a specific area of the icon. Here, even though the icon is displayed, it is not possible to execute a function provided by the icon.

In this case, there is a need to display an indication that the user is not allowed to touch the icon that cannot be executed. The following is a description of a method for adjusting display of icons which cannot be touched or whose functions cannot be executed through touch.

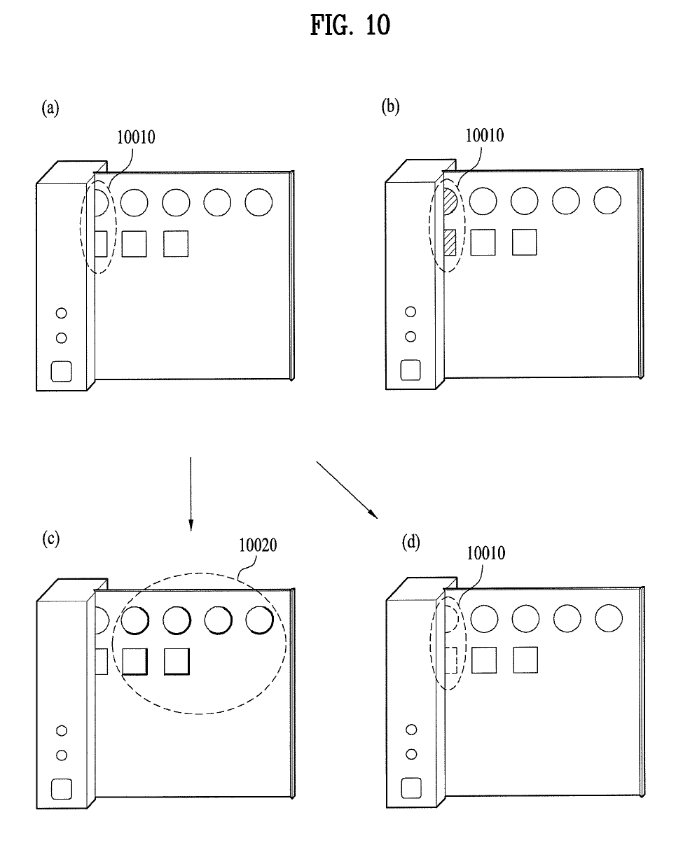

FIG. 10 illustrates a method for controlling display of a portable device according to another embodiment of the present invention.

Specifically, FIG. 10 illustrates a method for adjusting display of icons 10010, which are not fully displayed as the flexible display is extended, according to whether or not functions of the icons are executable. In an embodiment, the method of FIG. 10 may be used when less than a predetermined proportion of the area of an icon is displayed. The display adjustment method may be performed based on various criteria.

When some icons 10010 are not fully displayed as shown in FIG. 10(a), it is possible to determine whether or not the functions of the icons 10010 are executable through touch based on a specific criterion. When the functions of the icons 10010 are not executable even though the icons 10010 are displayed, the portable device adjusts display of the icons 10010. The portable device may impart a visual effect to each of the icons whose functions are not executable or to other icons. For example, the portable device may darken the icons 10010 as shown in FIG. 10(b). The portable device may also thicken touchable icons 10020 as shown in FIG. 10(c). The portable device may also display the untouchable icons 10010 transparently (or semitransparently). In these methods, the portable device displays the untouchable icons 10010 so as to allow the user to be aware that it is difficult to use the untouchable icons 10010 by displaying the untouchable icons 10010 dark or transparently (or semitransparently), i.e., by adjusting contrast of the icons 10010 or applying a graphic effect. Alternatively, the portable device displays the touchable icons 10020 so as to be easily identified by adjusting the contrast of the touchable icons 10020 or applying a graphic effect, for example, by displaying the touchable icons 10020 more strongly (or in more emphasis). These methods belong to the icon display adjustment methods described above.

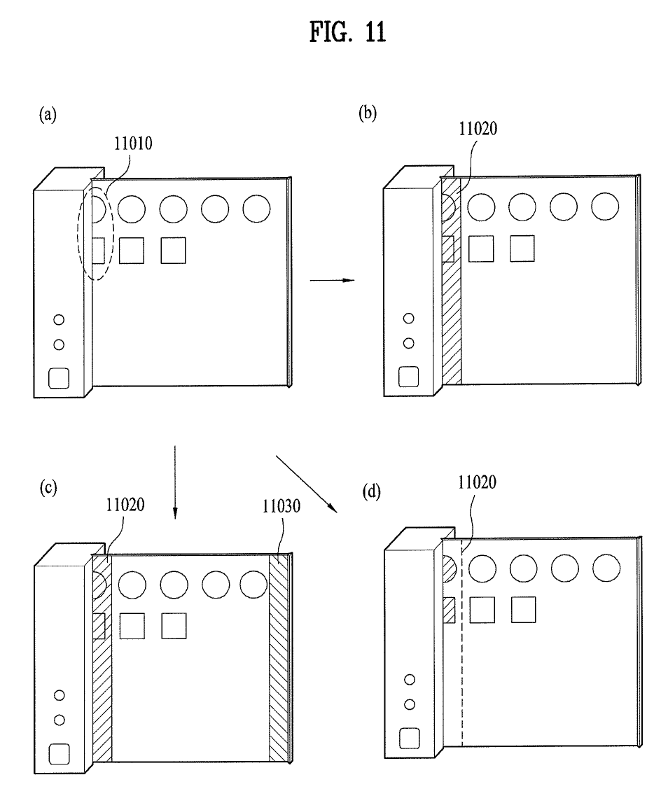

FIG. 11 illustrates a method for controlling display of a portable device according to another embodiment of the present invention.

Specifically, FIG. 11 illustrates a method in which, when icons 10010 are not fully displayed as the flexible display is extended, image display is adjusted according to whether or not functions of the icons 10010 are executable. That is, in the case of FIG. 11, the portable device adjusts display of an image displayed on the extended flexible display rather than adjusting display of the icons.

In addition, when the flexible display is extended, a region upon which it is difficult to make a touch input or whose functions it is difficult to execute through touch input may be displayed on the flexible display. The portable device may display such a region in a different manner or may display icons present in such a region in a different manner.

FIG. 11(a) illustrates a portable device when some icons cannot be fully displayed as the flexible display is extended. If the flexible display is extended, it may be difficult to make a touch input upon some portions, which may be both end portions of the flexible display. The portable device may impart a visual effect to such display regions.

FIG. 11(b) illustrates a method in which a visual effect is imparted to a region 11020, upon which it is difficult to make a touch input or whose functions it is difficult to execute through touch input, as a portion of the flexible display located at the boundary between the flexible display and the portable device. For example, the region 11020 may be displayed darker, brighter, more unclear, or more transparent than other regions of the display. In this case, since it is difficult to make a touch input upon the region 11020, the user may adjust the extension distance of the flexible display such that the region does not include icons or an icon that the user desires to use.

FIG. 11(c) illustrates an embodiment in which a portable-device-side portion 11020 and an opposite-side portion 11030 of the flexible display, upon which it is difficult to make a touch input or whose functions it is difficult to execute through touch input, are displayed distinguishably. It may be difficult to make a touch input upon not only a portable-device-side region of the flexible display but also an opposite-side region or it may be difficult to execute functions corresponding to both the regions through touch input even though touch input has been made upon the regions. Accordingly, in this case, an indication that it is difficult to make a touch input or it is difficult to execute a corresponding function even when a touch input has been made may be displayed not only for the portable-device-side region 11020 but also for the opposite-side region 11030. One method of displaying such an indication may include displaying the regions in various ways, for example, displaying the regions darker, brighter, more unclear, thicker, or more transparent than other regions of the display as described above. Such an indication may also be displayed for lower and upper edges of the display in addition to the regions 11020 and 11030 as shown in FIG. 11(c).

FIG. 11(d) illustrates an embodiment in which, when a region 11020, upon which it is difficult to make a touch input or it is difficult to execute a corresponding function through touch input, is present, icons present in the region 11020 are displayed distinguishably. When a region 11020, upon which it is difficult to make a touch input or it is difficult to execute a corresponding function through touch input, has been set in the portable device, the entirety of the region 11020 may not only be displayed distinguishably as shown in FIGS. 11(b) and 11(c) but may also not be displayed distinguishably when an object upon which a touch input is to be made, i.e., an icon whose function is to be executed through touch input, is not present in the region. Accordingly, when an object such as a touch-enabled icon is present in the region, the portable device may display the object using the method described above rather than displaying the region distinguishably.

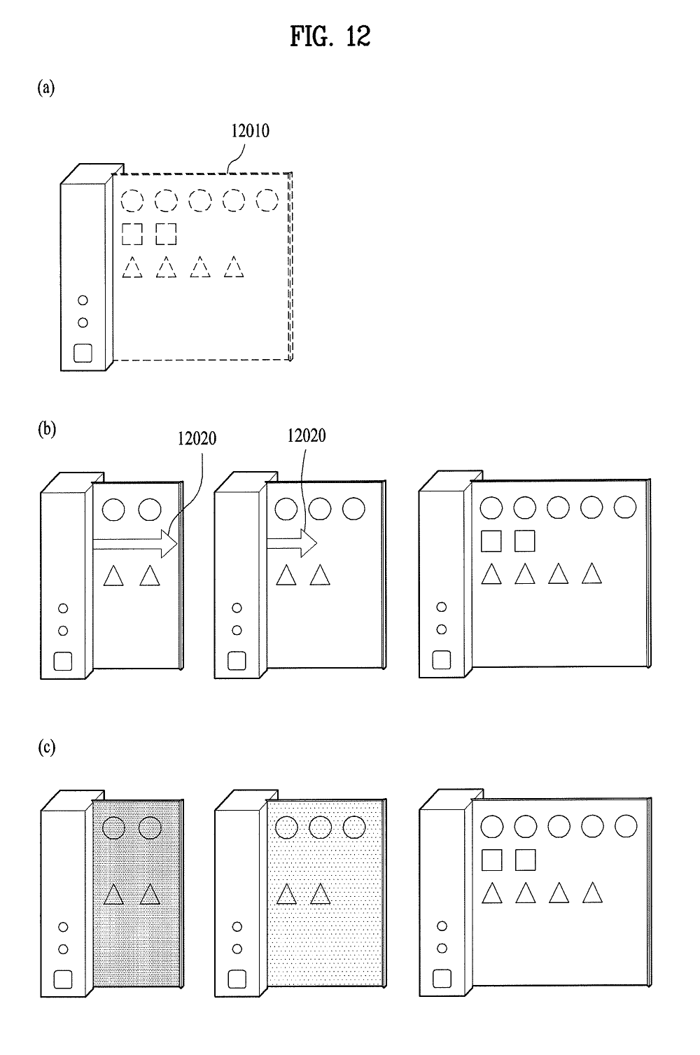

FIG. 12 illustrates a method for displaying an image of a portable device according to another embodiment of the present invention.

When a portable device displays a menu on a flexible display that can be rolled out to be extended from the portable device, the user may not know how much the flexible display needs to be extended to view the entirety of the menu. Thus, the portable device may indicate an area or distance by which the flexible display needs to be extended according to a menu or image to be displayed.

FIG. 12(a) illustrates an entire virtual image which can be displayed or is to be displayed. That is, FIG. 12(a) shows an entire image that is to be displayed when the user has extended the flexible display from the current position thereof. In this case, the portable device may automatically extend the flexible display until the entire image can be displayed and may also control the display to notify the user of an extended distance required to display the entire image when the user extends the flexible display.

FIG. 12(b) illustrates a portable device that indicates whether or not there is a need to further extend the flexible display by displaying an indicator 12020 such as an arrow on the flexible display that has been extended. In FIG. 12(b), the length of the arrow gradually decreases rightward. That is, the length of the arrow decreases as the extended distance of the flexible display approaches a distance at which the entire image can be displayed such that the arrow is removed when the entire image is displayed as shown in the rightmost figure. This allows the user to be aware that the flexible display is being extended as the length of the arrow decreases and that there is no need to further extend the flexible display to view the current image when the arrow has disappeared. The above indication method using the arrow is one embodiment and the arrow may be displayed at any position in various manners. As described above, the arrow is an indicator that notifies the user of the distance by which the flexible display needs to be extended to display the entire image.

FIG. 12(c) illustrates a portable device that indicates whether or not there is a need to further extend the flexible display by adjusting brightness or transparency of a screen displayed on a flexible display that has been extended. Similar to FIG. 12(b), the extent of extension of the flexible display increases and the distance by which the flexible display needs to be further extended decreases rightward in FIG. 12(c). In this case, the portable device initially displays the image dark and increases the brightness of the image as the extent of extension of the flexible display increases. Alternatively, the portable device initially displays the image transparently (or semitransparently) and increases the density (or thickness or the extent of emphasis) of the image as the extent of extension of the flexible display increases such that the image is displayed with optimal brightness or transparency when the virtual screen is fully displayed as shown in the rightmost figure. Through the screen, the user can intuitively extend the flexible display until the screen is satisfactorily viewed. That is, the user can extend the flexible display to the extent that the virtual screen is fully displayed.

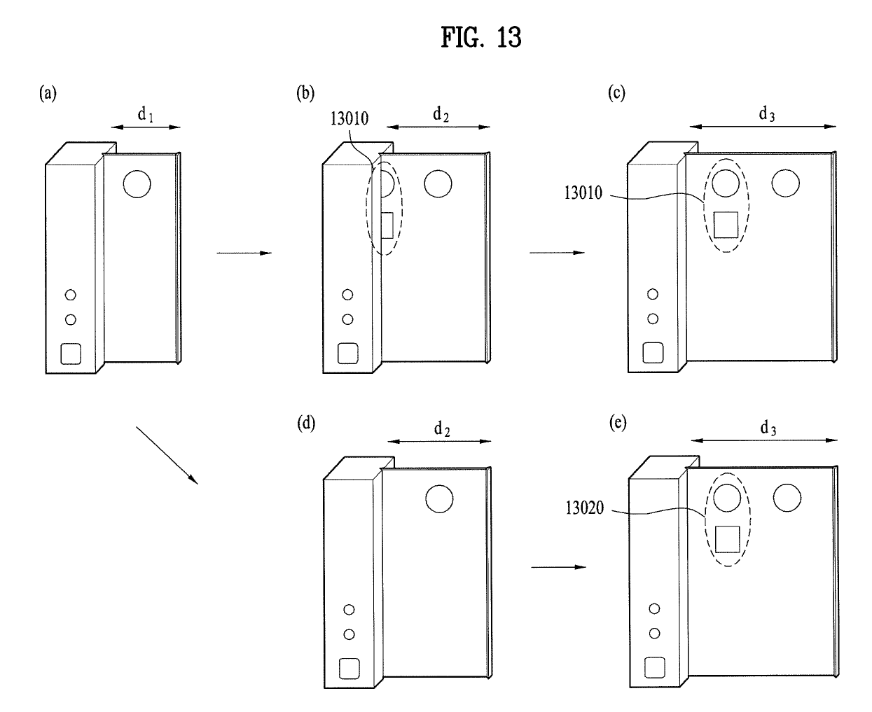

FIG. 13 illustrates a method for displaying an image of a portable device according to another embodiment of the present invention.

In most of the methods of the embodiments described above, image display is adjusted when menu icons are located on the flexible display at the boundary with the portable device depending on the extended distance of the flexible display. For example, the flexible display may be extended to a distance d1 as shown in FIG. 13(a) and may be extended to a distance d2 and a distance d3 as shown in FIGS. 13(b) and 13(c). In this case, since menu icons 13010 are displayed on a portion of the flexible display extended from the portable device, the menu icons 13010 are partially displayed as shown in FIG. 13(b) when the flexible display is extended to the distance d2. When the flexible display is further extended to the distance d3 which is sufficient to display the entirety of the menu icons, the menu icons 13010 are fully displayed as shown in FIG. 13(c).

However, the portable device may adjust image display so as not to display menu icons which are partially displayed since they are located at the boundary. That is, if the extension distance of the flexible display required to fully display the menu icons is the distance d3, the portable device may prevent the menu icons present in a region corresponding to the boundary from being displayed until the extension distance reaches the distance d3 and may then display the menu icons in the region when the extension distance reaches the distance d3. Specifically, when the extension distance of the flexible display is the distance d2, the portable device prevents display of the menu icons of the region as shown in FIG. 13(d) since it is not possible to fully display the menu icons of the region. Then, when the extension distance of the flexible display reaches the distance d3, the portable device fully displays the menu icons of the region as shown in FIG. 13(e). In this manner, the portable device may select and set specific menu icons 13010 and 13020 from an image on which menu icons are to be displayed on a virtual screen to be displayed and set the extension distance of the flexible display required to display the menu icons of the region. This can prevent the problem in that menu icons are only partially displayed on the flexible display at the boundary with the portable device depending on the extension distance of the flexible display as described above.

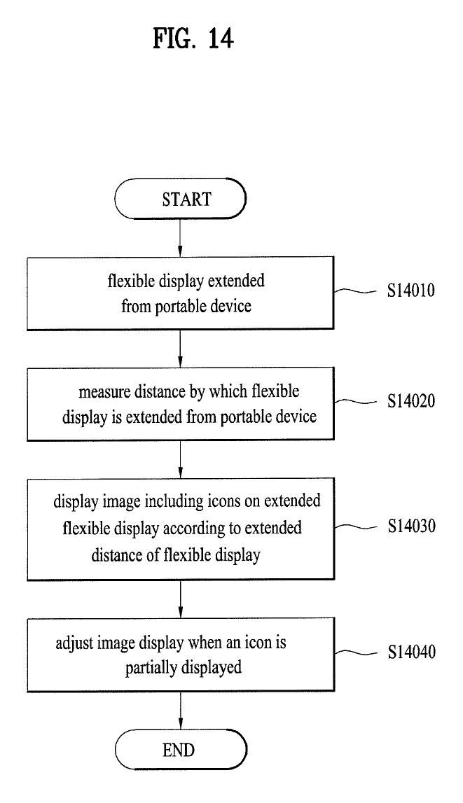

FIG. 14 is a flowchart illustrating a method for controlling a portable device according to an embodiment of the present invention.

The flexible display may be extended from the portable device (S14010).

The flexible display may be folded or rolled up to be contained in a housing that is externally or internally provided for the portable device. The flexible display may be automatically extended or may be manually extended by the user. The flexible display may be unfolded or rolled out according to the structure of the portable device and the housing.

When the flexible display is extended from the portable device, the portable device may measure the distance by which the flexible display has been extended (S14020).

The flexible display does not display an image while the flexible display is contained in the portable device. This can reduce power consumption and reduce unnecessary heat generation. Accordingly, when the flexible display is extended, the portable device may start displaying an image on a region that has become viewable by the user as the flexible display is extended from the housing (or housing unit). As described above, when the flexible display is rolled out from the portable device, the portable device may display an image on an exposed display portion of the portable device. To display an image on an extended portion of the flexible display, the portable device needs to know the extended distance or area of the flexible display. Accordingly, the portable device may measure the distance by which the flexible display has been extended using the sensor unit or the measurement sensor unit described above or may measure the extended area of the flexible display using the measured distance.

The measurement sensor unit may be provided in the housing to measure the distance by which the flexible display has been rolled out from the portable device. Alternatively, the flexible display may include a bending sensor to measure the unfolded distance or area of the flexible display. It is also possible to measure the extended distance of the flexible display by detecting touches (or contacts) occurring when the flexible display is extended from the housing the touch sensor provided on the flexible display. The housing may be located at any position of the portable device. Accordingly, the portable device may measure the extended distance of the flexible display by measuring the distance by which the flexible display has been extended from the housing or by measuring the extended distance of the flexible display, which is measured as a distance between both ends of an extended portion of the flexible display which has become able to display an image as the flexible display is extended from the portable device, or measuring the extended area of the flexible display.

The portable device may display an image including at least one icon on the extended flexible display according to the distance by which the flexible display has been extended (S14030).

The portable device may display various images according to extension of the flexible display using the display control unit. A GUI such as icons may be displayed to execute various applications as described above and such icons may often be displayed upon extension of the flexible display. In the case of a portable device having a main display as described above, it is possible to additionally display a menu screen other than a currently displayed screen on the extended flexible display.

While displaying an image according to the extended distance, the portable device may display an indicator of a distance by which the flexible display needs to be further extended as described above with reference to FIG. 12 or may control image display to notify the user of the distance.

The portable device may adjust image display when icons are partially displayed (S14040).

At least one icon may be partially displayed according to the extended distance or area of the flexible display as described above with reference to FIG. 6. In this case, the portable device may adjust image display using the display control unit. Methods for adjusting image display have already been described above with reference to FIGS. 6 to 13.

For example, when at least one icon is partially displayed on the flexible display at the boundary with the portable device, the portable device may adjust image display such that the icon is not displayed or is fully displayed. Alternatively, the portable device may impart a visual effect, different from that imparted to other icons, to the icon. Alternatively, the portable device may also impart a visual effect to icons other than the partially displayed icon. Examples of the visual effect include various effects that can be implemented according to the GUI such as contrast adjustment, color adjustment, resolution adjustment, black and white (brightness) adjustment, transparency adjustment, and flickering. Adjustment of an image including such icons may include rearranging the icons or imparting a visual effect to the icons. Such rearrangement includes adjusting the positions or order of the icons included in the image while adjusting the size of the icons or screen arrangement.

As described above, the portable device may horizontally move at least one displayed icon or the displayed image according to a touch input made by the user by sensing the touch input using the touch sensor provided on the flexible display as described above. When horizontally moving the icon or the display image, the portable device may magnify/demagnify other icons or the display image or may adjust the ratio, resolution, or the like thereof. When the display image has a region at which the at least one partially displayed icon can be fully displayed, the portable device may move the at least one icon to the region automatically or according to a touch input of the user and may then return the at least one icon to the original position when the flexible display is further extended.

It may be possible or impossible to make a touch input upon the partially displayed icon. It may be impossible to execute a function corresponding to the icon through touch input even though the touch input can be made upon the icon. Accordingly, when it is not possible to make a touch input upon icons or when it is not possible to execute applications or functions corresponding to the icons through touch input, the portable device may impart the visual effect described above to the icons. The portable device may also impart the visual effect to a region in which touch input cannot be made upon icons or the functions of the icons cannot be executed through touch input. Execution of an icon, execution of an application or function using the icon, or execution of the icon through touch input may be collectively referred to as activation of the icon.

According to the present invention, an image may be displayed according to the distance by which the flexible display has been extended, thereby preventing unnecessary power consumption and heat generation.

In addition, when icons are displayed according to extension of the flexible display, it is possible to minimize user inconvenience associated with the position of the icons or the extent of display of the icons.

When an icon is partially displayed according to the distance by which the flexible display has been extended, the user may try to further extend the flexible display to view the icon or may perform an unnecessary control operation since it is not possible to know whether or not the icon is touchable. According to the present invention, when an icon is partially displayed, image display is adjusted to suit user convenience.

In addition, according to the present invention, when the flexible display is extended, the user can know the distance or extent of extension of the flexible display required to display the entirety of a virtual image that can be displayed. Therefore, it is possible to efficiently extend or retract the flexible display.

Further, according to the present invention, the user can move a partially displayed icon as needed, thereby minimizing unnecessary control operations of the portable device.

The present invention can be partially or fully applied to an electronic device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a portable device including a flexible display and a housing that contains the flexible display, the method comprising:
extending the flexible display from the housing;
measuring a distance by which the flexible display has been extended from the portable device;
displaying an image including at least one icon on the extended flexible display according to the measured distance; and
adjusting the image display when the at least one icon is partially displayed.

2. The method according to claim 1, wherein adjusting the image display includes at least one of rearranging the at least one icon or imparting a visual effect to the at least one icon.

3. The method according to claim 1, wherein adjusting the image display includes adjusting the image such that the at least one partially displayed icon is not displayed on the extended flexible display.

4. The method according to claim 1, wherein adjusting the image display includes adjusting the image such that the at least one partially displayed icon is fully displayed on the extended flexible display.

5. The method according to claim 1, wherein adjusting the image display includes imparting a visual effect to the at least one partially displayed icon.

6. The method according to claim 1, wherein the icon is a GUI that enables execution of an application or function that can be executed on the portable device.

7. The method according to claim 1, wherein the flexible display can sense touch input.

8. The method according to claim 7, wherein adjusting the image display includes imparting a visual effect to the at least one partially displayed icon when the at least one partially displayed icon cannot be activated through touch input.

9. A portable device comprising:
a flexible display;
a housing that contains the flexible display;
a measurement sensor for measuring a distance by which the flexible display has been extended from the portable device when the flexible display is extended from the housing; and
a display control unit for displaying an image including at least one icon on the extended flexible display according to the measured distance,
wherein the display control unit adjusts the image display when the at least one icon is partially displayed on the extended flexible display.

10. The portable device according to claim 9, wherein the display control unit adjusts the image display by rearranging the at least one icon or imparting a visual effect to the at least one icon.

11. The portable device according to claim 9, wherein the display control unit adjusts the image such that the at least one partially displayed icon is not displayed on the extended flexible display.

12. The portable device according to claim 9, wherein the display control unit adjusts the image such that the at least one partially displayed icon is fully displayed on the extended flexible display.

13. The portable device according to claim 9, wherein the display control unit imparts a visual effect to the at least one partially displayed icon.

14. The portable device according to claim 9, wherein the icon is a GUI that enables execution of an application or function that can be executed on the portable device.

15. The portable device according to claim 9, wherein the flexible display can sense touch input.

16. The portable device according to claim 15, wherein the display control unit imparts a visual effect to the at least one partially displayed icon when the at least one partially displayed icon cannot be activated through touch input.
